(19) United States
(12) Patent Application Publication
(10) Pub. No.: US 2026/0062155 A1
(43) Pub. Date: Mar. 5, 2026

(54) METHODS AND APPARATUS FOR TAIL DEPLOYMENT IN AIR LAUNCHED EFFECTS SYSTEMS

(71) Applicant: The Boeing Company, Arlington, VA (US)

(72) Inventors: Alexander Andryukov, Gainesville, VA (US); Jacob Voelckers, Manassas, VA (US)

(21) Appl. No.: 18/798,272

(22) Filed: Aug. 8, 2024

(51) Int. Cl. B64U 20/50; B64U 30/40; B64U 70/50

(52) U.S. Cl. CPC B64U 20/50; B64U 30/40; B64U 70/50

(57) ABSTRACT

Methods and apparatus for tail deployment in air launched effects (ALE) systems are disclosed. A disclosed example apparatus for deploying a tail for a launchable aircraft includes a spring having a first end and a second end, and a rotational hub operatively coupled to a rotational joint of a fuselage of the aircraft, the rotational hub operatively coupled to the first end of the spring, the second end of the spring operatively coupled to the tail, the spring to urge the tail to move relative to the fuselage when the aircraft is launched from a host.

### FIELD OF THE DISCLOSURE

This disclosure relates generally to aircraft and, more particularly, to methods and apparatus for tail deployment in air launched effects systems.

### BACKGROUND

Air launched effects (ALE) systems employ a mechanical system to enable folded tail/control surfaces to deploy after launch from a host in a fixed size circular or square tube form factor. In particular, the foldable tails are sized according to span, chord and airfoil, mass, inertia, strength, and stiffness to satisfy the gross take-off weight (GTOW) requirements, center-of-gravity (CG) requirements, as well as launch tube requirements. The tail mechanism is necessitated to deploy the tails in a relatively quick manner due to a changing load as the tails transition from stowed forward, opening rearward to a nominal deployment state.

Known ALE systems rely on swinging or hinging tails on a single pivot or multiple pivots. In a specific known ALE implementation, three identical tails are rotated with independent pivots. The tails are moved via a torsion spring at a base from a stowed state to a deployed state. In the stowed state, the tails can lie relatively flat against a fuselage and, during deployment, the tails spring open, lock, and pivot via independent electrical servos and pushrods.

### SUMMARY

An example apparatus for deploying a tail for an aircraft includes a spring having a first end and a second end, and a rotational hub operatively coupled to a rotational joint of a fuselage of the aircraft, the rotational hub operatively coupled to the first end of the spring, the second end of the spring operatively coupled to the tail, the spring to urge the tail to move relative to the fuselage when the aircraft is launched from a host.

An example tail assembly for an aircraft includes a tail having a channel, a spring disposed in the channel, and a hub to be rotatably coupled to a spindle of a fuselage of the aircraft, the spring operatively coupled to the hub and the tail, the spring to urge the tail to rotate for deployment thereof.

An example method of producing a tail for an aircraft includes placing a spring in a recess of the tail, operatively coupling the spring between a rotational hub and the tail, and operatively coupling the rotational hub to a rotational joint of a fuselage to enable the spring to urge the tail to move relative to the fuselage when the aircraft is launched from a host.

### BRIEF DESCRIPTION OF THE DRAWINGS

FIG. 1 is an example aircraft launch system in which examples disclosed herein can be implemented.

FIG. 2 depicts folding of an example aircraft of FIG. 1.

FIG. 3 is an exploded view of an example folding apparatus in accordance with teachings of this disclosure.

FIG. 4 is an exploded view of another alternative example folding apparatus in accordance with teachings of this disclosure.

FIG. 5 is a flowchart of an example method to produce examples disclosed herein.

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

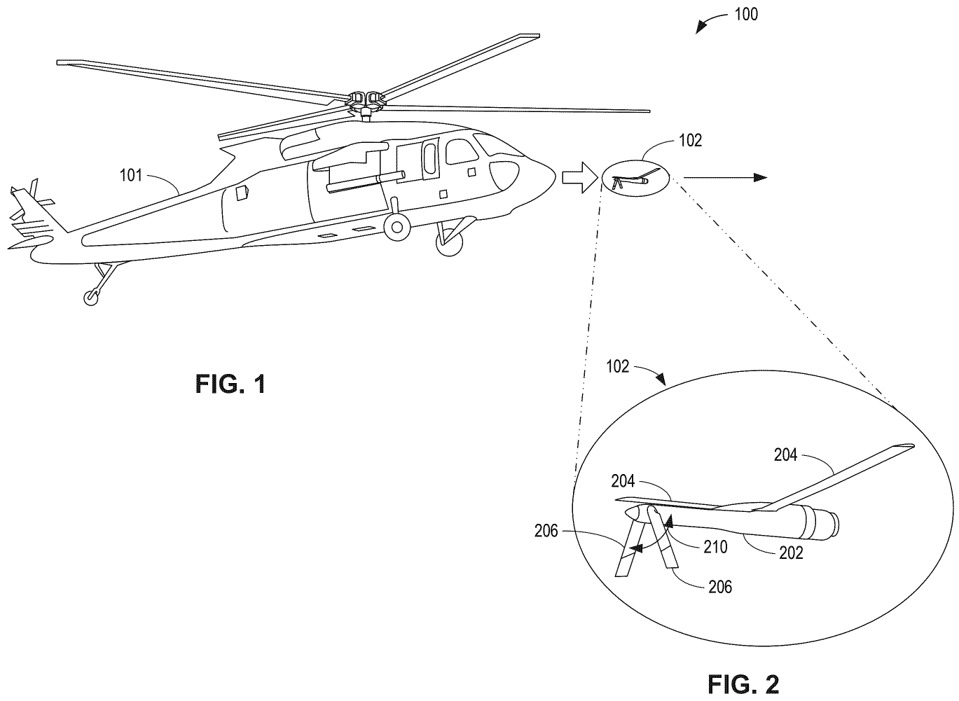

FIG. 1 is an example aircraft launch system 100 in which examples disclosed herein can be implemented. In particular, FIG. 1 depicts an aircraft launched effects (ALE) implementation in which an aircraft 102 is launched from a host 101, which is also implemented as an aircraft in this example. In other examples, the host 101 may be a ground-based vehicle, an unmanned aerial vehicle (UAV), a stationary launcher, a ground-based launcher, a water-bound launcher, a maritime launcher, etc. In this particular example, the aircraft 102 is launched from the host 101 while the host 101 moves and/or is being controlled/piloted.

According to examples disclosed herein, the aircraft 102 is launched and/or deployed from the host 101 in a folded/stowed state generally resembling the shape of a cylinder or other elongate structure, for example. Accordingly, subsequent to the aircraft 102 being launched in the folded/stowed state, components and/or aerodynamic surfaces of the aircraft 102 are unfolded and/or moved outward relative to external surfaces of the aircraft 102. As will be discussed below in connection with FIGS. 2-5, examples disclosed herein deploy and/or unfold at least one tail and/or tail portion of an aircraft with lightweight components, thereby reducing and/or eliminating a need for disadvantageously heavier devices, such as actuators or motors, that can necessitate significant volume as well, which volume could otherwise be dedicated to other purposes, such as to store more and/or larger payloads. Further, in known implementations, actuators are relied upon for maintaining a position and/or orientation of control surfaces, thereby necessitating stronger (and heavier) components to reduce a probability of potential damage and/or improper control, also disadvantageously adding weight plus reducing available space within the aircraft, e.g., for more and/or larger payload.

FIG. 2 depicts the example aircraft 102 of FIG. 1. The aircraft 102 is an unmanned aerial vehicle (UAV) in a foldable fixed wing implementation. The example aircraft 102 is foldable for storage/stowage and can expand and/or unfold in response to being launched and/or released from the host 101 shown in FIG. 1. In the illustrated example of FIG. 2, the aircraft 102 includes a fuselage 202 with wings 204 and a tail 206 extending therefrom.

In this example, the tail 206 folds in an outward direction relative to the fuselage 202 when the aircraft 102 is launched (e.g., in an ALE implementation). In particular, motion of the aircraft 102 during flight and spring-based devices/mechanisms cause the tail 206 to unfold. In particular, the tail 206 can be passively unfolded via a spring force as the aircraft 102 is launched. In other words, the tail 206 can be deployed via passive activation. In some examples, a flow of air past the tail 206 facilities and/or causes unfolding thereof. In particular, the tail 206 can be rotated inward/outward, as generally indicated by a double arrow 210. Examples disclosed herein utilize springs to unfold aerodynamic surfaces, such as wings, stabilizers or tails, relative to the fuselage 202. While the example of FIG. 2 includes a foldable tail, other examples may correspond to other rotatable components and/or sections of a vehicle.

While examples disclosed herein are shown and described in the context of unmanned aircraft, examples disclosed herein can be implemented in vehicles, manned aircraft, non-fixed wing aircraft, watercraft, submersibles, spacecraft, ground-based vehicles, etc.

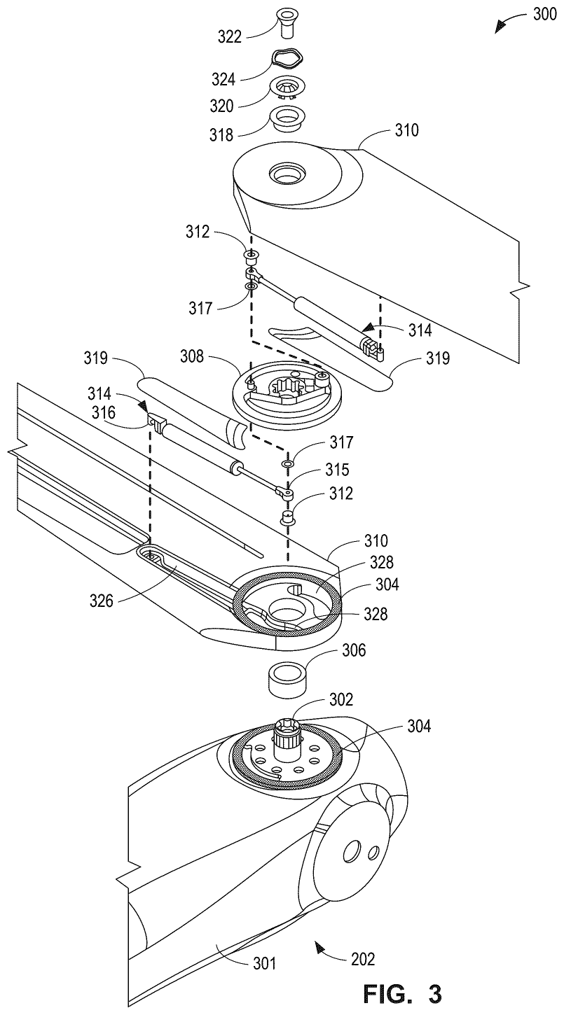

FIG. 3 is an exploded view of an example folding apparatus 300 in accordance with teachings of this disclosure. In the illustrated example of FIG. 3, the folding apparatus 300 is shown implemented as a stack-up (e.g., a stacked configuration, rotational axis stack-up, etc.) in an exploded state in conjunction with the fuselage 202. In particular, the example folding apparatus 300 is assembled and/or rotatably coupled to a fuselage body 301 of the fuselage 202.

According to examples disclosed herein, the folding apparatus 300 includes a rotational joint (e.g., a spindle, a tail spindle, a keyed joint, a rotational joint, a spindle joint, etc.) 302, anti-friction shims 304, a sleeve bearing 306, a rotational hub (e.g., a tail hub, a tail ground, etc.) 308, tails (e.g., horizontal tails, horizontal tail portions, etc.) 310, bearings (e.g., sleeve bearings) 312, springs (e.g., gas compression springs, fluid dampers, shocks, suspension elements, spring elements, etc.) 314, each of which includes an eye (e.g., rod eye, a rod end, etc.) 315 and a pin (e.g., a pin end, a pin interface, etc.) 316, washers 317, a sleeve bearing 318, covers (e.g., spring covers, tail surface portions, tail surface covers, etc.) 319, a retention washer 320, and a fastener (e.g., a screw, a tail screw, etc.) 322. In some examples, at least one wave spring 324 is implemented.

To rotationally couple the tails 310 to the fuselage 202, the fastener 322 is threaded into the rotational joint 302 and extends through the rotational hub 308. In this example, the rotational joint 302 includes a key and/or spindle (e.g., a spindle aperture, a keyed feature, etc.) to interface and/or rotationally lock with an aperture of the rotational hub 308 (e.g., a keyed aperture of the rotational hub 308, a spindle joint interface of the rotational hub 308, etc.). In this example, the fastener 322 is tightened/torqued to impart a pre-load to the stack-up shown in FIG. 3. In other words, the fastener 322 can be tightened/torqued to compress the stack-up including both of the tails 310. According to examples disclosed herein, the tails 310 are enabled to be closer to an aft position of an aircraft, which can be particularly advantageous in aircraft applications, and can also result in a relatively quicker deployment response than known systems.

To enable the springs 314 to urge the respective tails 310 to their deployed and/or unfolded/unstowed positions, each of the springs 314 is operatively coupled to the respective tails 310 at a first end (e.g., a first distal end) of the springs 314 corresponding to the pin 316 (e.g., the pin 316 interfaces with a step and/or protrusion of the corresponding tail 310) and the rotational hub 308 at a second end (e.g., a second distal end) of the springs 314 corresponding to the eye 315. According to examples disclosed herein, when an aircraft (e.g., the aircraft 102 of FIG. 1) is launched, the springs 314 cause the rotational hub 308 to rotate about the rotational joint 302, thereby causing the tails 310 to unfold. In this example, both of the springs 314 are operatively coupled to opposing sides/ends of the rotational hub 308 and are implemented as gas compression springs to advantageously provide a sufficient force and/or force profile imparted to the tails 310 in a relatively short time frame. In this example, the tails 310 are deployed in opposite directions (e.g., opposite rotational directions) from one other.

In this example, the springs 314 are at least partially disposed within channels (e.g., cavities, recesses, etc.) 326 of the corresponding tails 310, thereby reducing volume typically and disadvantageously necessitated in known ALE devices. By utilizing the channels 326, examples disclosed herein can reduce complexity of parts, which can typically entail disadvantageously expensive manufacturing processes. The channels 326 can also advantageously free up fuselage volume/space for additional equipment, payloads, etc. Further, according to examples disclosed herein, curved slots 328 are implemented in the tails 310 to enable rotation of the tails 310 relative to the rotational hub 308. In particular, the example curved slots 328 are defined in a cylindrical cavity of the tails 310.

In this example, the tails 310 and/or the covers 319 are at least partially composed of carbon fiber reinforced polymer (CFRP) (e.g., foam core stiffened CFRP, etc.) and the channels 326 and/or the curved slots 328 are molded into the tails 310. In other examples, the channels 326 and/or the curved slots 328 are defined in a process, such as machining, etching, material removal, etc. Further, in the illustrated example of FIG. 3, the covers 319 each define at least a portion and/or contour of an external surface of the respective tail 310.

To reduce friction and/or rotational resistance of the tails 310 (e.g., during deployment of the tails 310, during folding of the tails 310, etc.), multiple ones of the anti-friction shims 304 are utilized. In some examples, the anti-friction shim 304 includes and/or is at least partially composed of polytetrafluoroethylene (PTFE), stainless steel, etc. Additionally or alternatively, one or more of the anti-friction shims 304 include an adhesive side (e.g., a self-adhesive side, an adhering side, etc.). However, any other appropriate material, device, application (e.g., chemical application, lubricant application, adhesive application etc.) and/or mechanism for reducing friction and/or rotational resistance can be implemented instead.

In some examples, the rotational joint 302 includes a locking helicoil to threadably couple the fastener 322 thereto. However, any other appropriate locking and/or restraining mechanism can be implemented instead. In some examples, the tails 310 each include a pivot stop feature and/or geometry to rotationally constrain a movement thereof. Additionally, or alternatively, the rotational joint 302 is at least partially composed of aluminum (e.g., machined aluminum, cast aluminum, etc.). In some examples, the rotational hub 308 includes a stop or a surface that contacts a surface of the fuselage body 301 to prevent and/or constrain further rotation thereof.

Accordingly, examples disclosed herein can rely on spring forces urging the tails 310 to a respective deployed rotational position without necessitating typical servos and/or actuators to maintain the tails 310 in their deployed positions, thereby saving weight and volume, which can be particularly advantageous in aircraft applications. In some examples, sleeve bearings at least partially composed of a polymer, such as a PTFE (e.g., Rulon®) are implemented.

While two of the springs 314 are shown in this example, any appropriate number of springs (e.g., one, three, four, five, etc.) can be implemented instead. Further, any appropriate device to provide a spring force and/or force profile to the tails 310 can be implemented instead. In this example, the tails 310 deploy along a single plane (e.g., a common plane). In other examples, the tails 310 deploy along different planes.

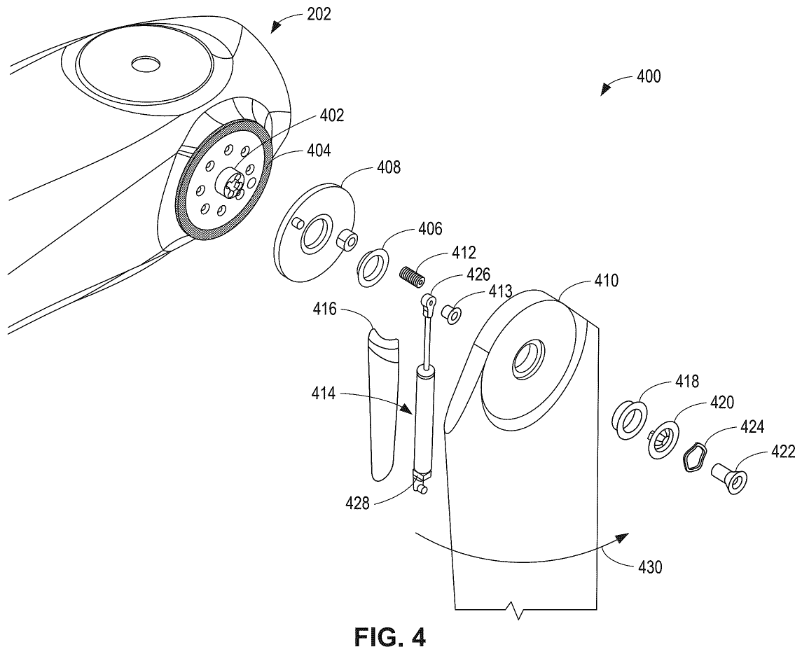

FIG. 4 is an exploded view of another alternative example folding apparatus 400 in accordance with teachings of this disclosure. The folding apparatus 400 of the illustrated example is similar to the example folding apparatus 300, but is instead utilized as a vertical tail deployment system (as opposed to a horizontal tail deployment system). In this example, the folding apparatus 400 is operatively coupled to the fuselage 202.

In the illustrated example of FIG. 4, the folding apparatus 400 includes a rotational joint 402, an anti-friction shim 404, a sleeve bearing 406, a rotational hub (e.g., a shear fitting) 408, a tail 410, a shear fastener (e.g., a shear screw, a shear pin, etc.) 412, a bearing (e.g., a sleeve bearing) 413, a spring 414 that is implemented as a gas compression spring in this example, a cover 416, a sleeve bearing 418, a retention washer 420, and a fastener (e.g., a tail fastener, etc.) 422. According to some examples disclosed herein, a wave spring 424 is utilized to enable a pre-load for the stack-up shown in FIG. 4. In contrast to the example of FIG. 3, a first end 426 of the spring 414 is an eye end that is threaded and/or includes threads to be threadably coupled to the shear fastener 412 which, in turn, is threadably coupled to the rotational hub 408. In this example, the fastener 422 is threadably coupled to the rotational hub 408 (e.g., via a locking helicoil, a chemical thread lock, etc.). Further, a second end 428 of the spring 414 is a rod end to be operatively coupled to (e.g., rotatably coupled to) to the tail 410.

In some examples, the spring 414 is at least partially placed into a channel and/or a recess of the tail 410 (e.g., molded into the tail 410, machined or cut from the tail 410, etc.), as shown in the example of FIG. 3. Accordingly, the tail 410 can be relatively light weight, which can be particularly advantageous for aircraft, amongst other applications. Additionally, or alternatively, according to some examples disclosed herein, the tail 410 and/or the cover 416 is/are at least partially composed of CFRP.

In operation, release of the spring 414 from compression causes the tail 410 to rotate downward (in the view of FIG. 4), as generally indicated by an arrow 430. In particular, when the tail 410 is enabled to rotate (e.g., during or subsequent to launch of the aircraft 102 from the host 101, based on a release mechanism of the aircraft 102, released from a rotational lock, etc.), the spring 414 urges the rotational hub 408 and, in turn, the tail 410 to rotate relative to the rotational joint 402. According to some examples disclosed herein, a stop feature and/or surface of the tail 410 can contact a component of the fuselage 202 and/or a feature/component/surface of the fuselage 202 to prevent further rotation of the tail 410 (e.g., in a deployed state).

In some examples, the anti-friction shim 404 includes and/or is at least partially composed of PTFE, stainless steel, etc. However, any other appropriate material(s) can be implemented instead. In some examples, the rotational joint 402 includes an opening, aperture and/or hollow to enable wiring (e.g., upper tail servo wiring, servo wiring, etc.) to pass therethrough. In some examples, at least one component of the tail 410, such as a tail body/mold for example, is common with the tails 310 shown and described above in connection with FIG. 3.

Any of the example aspects, components and/or features described and mentioned with respect to FIG. 4 can be implemented in other examples disclosed herein and, likewise, any other aspects disclosed herein can be implemented in conjunction with the example of FIG. 4 (or any other examples).

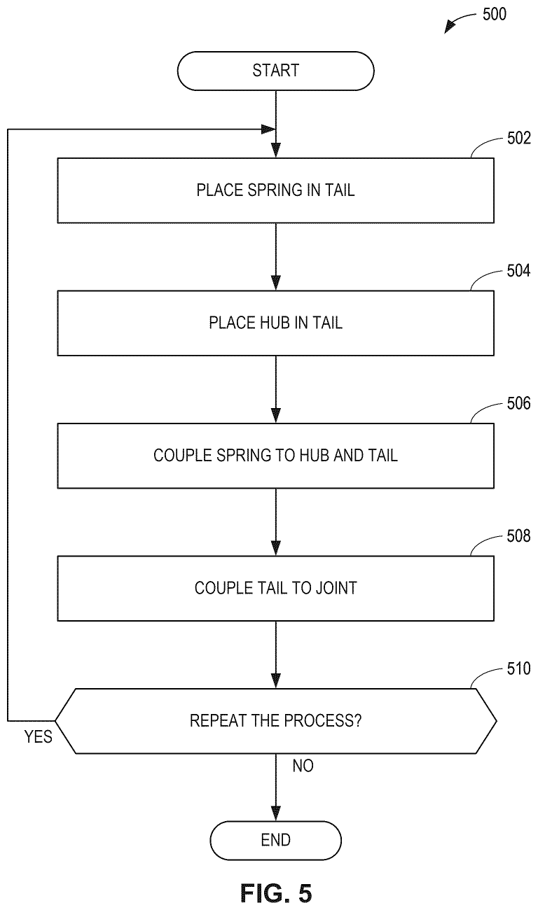

FIG. 5 is a flowchart of an example method 500 to produce examples disclosed herein. In this example, the method 500 is utilized to produce, assemble, service and/or retrofit an unmanned aircraft (or other vehicle) that can be deployed from a host, which may be another aircraft. In some examples, the method 500 is utilized for upgrading a vehicle.

At block 502, a spring (e.g., the spring 314, the spring 414), is placed in a tail (e.g., the tail 310, the tail 410). In this example, the spring is a gas compression spring that is placed in a channel and/or recess of the tail.

At block 504, a rotational hub (e.g., the rotational hub 308, the rotational hub 408) is placed within a recess of the tail. In this particular example, the rotational hub is placed within a cylindrical aperture of the tail.

At block 506, the spring is operatively coupled to the rotational hub and the tail. In this example, a first end of the spring is coupled to the rotational hub and a second end of the spring that is opposite to the first end is coupled to the tail (e.g., at a protrusion or raised step of a recess of the tail).

At block 508, the tail is operatively coupled to the rotational joint. In this example, a fastener is utilized to assemble and align the tail to the rotational joint of a fuselage of the aircraft. In some examples, the tail is assembled to the rotational joint with a shear fastener/device operatively coupled therebetween.

At block 510, it is determined whether to repeat the process. If the process is to be repeated (block 510), the process returns to block 502. Otherwise, the process ends.

Example methods, apparatus, systems, and articles of manufacture to enable effective and weight-saving deployment of control surfaces are disclosed herein. Further examples and combinations thereof include the following:
Example 1 includes an apparatus for deploying a tail for an aircraft, the apparatus comprising a spring having a first end and a second end, and a rotational hub operatively coupled to a rotational joint of a fuselage of the aircraft, the rotational hub operatively coupled to the first end of the spring, the second end of the spring operatively coupled to the tail, the spring to urge the tail to move relative to the fuselage when the aircraft is launched from a host.
Example 2 includes the apparatus as defined in example 1, wherein the rotational hub and the rotational joint define a spindle joint interface therebetween.
Example 3 includes the apparatus as defined in any of examples 1 or 2, wherein the spring is a first spring and the tail is a first tail, and further including a second spring having a third end and a fourth end, the third end operatively coupled to the rotational hub and the fourth end operatively coupled to a second tail.
Example 4 includes the apparatus as defined in example 3, wherein the first end of the first spring and the third end of the second spring are on opposing sides of the rotational hub.
Example 5 includes the apparatus as defined in any of examples 1 to 3, further including a wave spring, the wave spring to be compressed with a fastener that secures the tail to the rotational joint.
Example 6 includes the apparatus as defined in any of examples 1 to 5, further including a sleeve bearing to rotationally couple the tail to the rotational joint.
Example 7 includes the apparatus as defined in any of examples 1 to 6, wherein the spring is a gas spring.
Example 8 includes the apparatus as defined in any of examples 1 to 7, wherein the tail includes a recess or channel to receive the spring.
Example 9 includes a tail assembly for an aircraft, the tail assembly comprising a tail having a channel, a spring disposed in the channel, and a hub to be rotatably coupled to a spindle of a fuselage of the aircraft, the spring operatively coupled to the hub and the tail, the spring to urge the tail to rotate for deployment thereof.
Example 10 includes the tail assembly as defined in example 9, wherein the spring is a first spring and the tail is a first tail, and further including a second spring operatively coupled to the hub at an opposing side of the hub from the first spring, the second spring to urge a second tail to rotate in a direction opposite to that of the first tail.
Example 11 includes the tail assembly as defined in example 10, wherein the first tail and the second tail rotate along a same plane.
Example 12 includes the tail assembly as defined in any of examples 9 to 11, further including a cover to at least partially enclose the channel and at least partially define an exterior surface of the tail.
Example 13 includes the tail assembly as defined in any of examples 9 to 12, further including a shear fastener to operatively couple the spring to the hub, the shear fastener to be threaded into the hub.
Example 14 includes the tail assembly as defined in any examples 9 to 13, further including a wave spring to be compressed by a fastener that secures the tail to the spindle.
Example 15 includes the tail assembly as defined in any of examples 9 to 14, wherein the spindle and the hub include a spline interface therebetween.
Example 16 includes the tail assembly as defined in any of examples 9 to 15, wherein the spindle includes an aperture to enable cabling to extend between the fuselage and the tail.
Example 17 includes a method of deploying a tail for an aircraft, the method comprising placing a spring in a recess of the tail, operatively coupling the spring between a rotational hub and the tail, and operatively coupling the rotational hub to a rotational joint of a fuselage to enable the spring to urge the tail to move relative to the fuselage when the aircraft is launched from a host.
Example 18 includes the method as defined in example 17, further including placing a wave spring between a fastener and the tail, wherein the fastener is to be threadably coupled to the rotational joint of the fuselage.
Example 19 includes the method as defined in any of examples 17 or 18, further including placing a sleeve bearing between the rotational joint and the tail.
Example 20 includes the method as defined in any of examples 17 to 19, wherein the spring is a first spring and the tail is a first tail, and further including operatively coupling a second spring to the rotational hub, the second spring operatively coupled to a second tail.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

From the foregoing, it will be appreciated that example systems, apparatus, articles of manufacture, and methods have been disclosed that enable relatively lightweight and cost effective deployment control surfaces for aircraft. Examples disclosed herein can also enable weight savings and complexity reductions by reducing a need for servos or actuators utilized in known implementations. Examples disclosed herein can reduce (e.g., minimize) machining complexity. Moreover, examples disclosed herein can maintain or increase a suitable internal volume of an aircraft for other systems and payloads.

Examples disclosed herein capitalize on the flexibility in design, strength, stiffness, and mass by using a foam stiffened CFRP tail structure. According to examples disclosed herein, gas springs can be fully contained within a molded tail pocket, which can free up internal volume for payloads and reduce overall weight. Further, example tails can also contain deployment ground attachments with a relatively minimal incursion into an internal space thereof.

According to examples disclosed herein, tails can be advantageously positioned further aft without compromising a relationship between the wing and center-of-gravity (CG). By utilizing relatively lightweight foam core stiffened CFRP, a resultant lower tail inertia can enable a relatively quicker deployment response and, thus, can enable relatively quicker control of an aircraft subsequent to launch. Further, in accordance with examples disclosed herein, tails can deploy in a single plane instead of through multiple pivots and reduce a need for active servo control. As a result, operation complexity can be reduced, thereby limiting a number of inputs necessitated to successfully actuate the tails after launch, and reducing (e.g., minimizing mass/weight) while increasing payload volume or enabling a reduction in overall volume.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus for deploying a tail for an aircraft, the apparatus comprising:
a spring having a first end and a second end; and
a rotational hub operatively coupled to a rotational joint of a fuselage of the aircraft, the rotational hub operatively coupled to the first end of the spring, the second end of the spring operatively coupled to the tail, the spring to urge the tail to move relative to the fuselage when the aircraft is launched from a host.

2. The apparatus as defined in claim 1, wherein the rotational hub and the rotational joint define a spindle joint interface therebetween.

3. The apparatus as defined in claim 1, wherein the spring is a first spring and the tail is a first tail, and further including a second spring having a third end and a fourth end, the third end operatively coupled to the rotational hub and the fourth end operatively coupled to a second tail.

4. The apparatus as defined in claim 3, wherein the first end of the first spring and the third end of the second spring are on opposing sides of the rotational hub.

5. The apparatus as defined in claim 1, further including a wave spring, the wave spring to be compressed with a fastener that secures the tail to the rotational joint.

6. The apparatus as defined in claim 1, further including a sleeve bearing to rotationally couple the tail to the rotational joint.

7. The apparatus as defined in claim 1, wherein the spring is a gas spring.

8. The apparatus as defined in claim 1, wherein the tail includes a recess or channel to receive the spring.

9. A tail assembly for an aircraft, the tail assembly comprising:
a tail having a channel;
a spring disposed in the channel; and
a hub to be rotatably coupled to a spindle of a fuselage of the aircraft, the spring operatively coupled to the hub and the tail, the spring to urge the tail to rotate for deployment thereof.

10. The tail assembly as defined in claim 9, wherein the spring is a first spring and the tail is a first tail, and further including a second spring operatively coupled to the hub at an opposing side of the hub from the first spring, the second spring to urge a second tail to rotate in a direction opposite to that of the first tail.

11. The tail assembly as defined in claim 10, wherein the first tail and the second tail rotate along a same plane.

12. The tail assembly as defined in claim 9, further including a cover to at least partially enclose the channel and at least partially define an exterior surface of the tail.

13. The tail assembly as defined in claim 9, further including a shear fastener to operatively couple the spring to the hub, the shear fastener to be threaded into the hub.

14. The tail assembly as defined in claim 9, further including a wave spring to be compressed by a fastener that secures the tail to the spindle.

15. The tail assembly as defined in claim 9, wherein the spindle and the hub include a spline interface therebetween.

16. The tail assembly as defined in claim 9, wherein the spindle includes an aperture to enable cabling to extend between the fuselage and the tail.

17. A method of producing a tail for an aircraft, the method comprising:
placing a spring in a recess of the tail;
operatively coupling the spring between a rotational hub and the tail; and
operatively coupling the rotational hub to a rotational joint of a fuselage to enable the spring to urge the tail to move relative to the fuselage when the aircraft is launched from a host.

18. The method as defined in claim 17, further including placing a wave spring between a fastener and the tail, wherein the fastener is to be threadably coupled to the rotational joint of the fuselage.

19. The method as defined in claim 17, further including placing a sleeve bearing between the rotational joint and the tail.

20. The method as defined in claim 17, wherein the spring is a first spring and the tail is a first tail, and further including operatively coupling a second spring to the rotational hub, the second spring operatively coupled to a second tail.
